(19) United States
(12) Patent Application Publication
(10) Pub. No.: US 2022/0065263 A1
(43) Pub. Date: Mar. 3, 2022

(54) CENTRIFUGAL BLOWER

(71) Applicant: DENSO CORPORATION, Kariya-citty (JP)

(72) Inventors: Syo KOSAKA, Kariya-citty (JP); Syuzou ODA, Kariya-citty (JP)

(21) Appl. No.: 17/454,332

(22) Filed: Nov. 10, 2021

Related U.S. Application Data
(63) Continuation of application No. PCT/JP2020/017395, filed on Apr. 22, 2020.

(30) Foreign Application Priority Data
May 15, 2019 (JP) 2019-092293

(51) Int. Cl. F04D 29/42; F04D 17/08

(52) U.S. Cl. CPC F04D 29/4213; F04D 17/08

(57) ABSTRACT

A centrifugal blower has a scroll casing, and a separation cylinder. The scroll casing has a nose portion having a minimum scroll diameter and a scroll end portion having a maximum scroll diameter. A suction port of the scroll casing is divided into a first half region and a second half region by a reference line passing through a rotation axis and the nose portion. An air introduction portion of the separation cylinder is arranged to have an area overlapping the first half region in the axial direction, which is larger than an area overlapping the second half region. An outer peripheral wall of the scroll casing is set such that a divergence angle from the nose portion to an intermediate portion is larger than a divergence angle from the intermediate portion to the scroll end portion.

### CROSS REFERENCE TO RELATED APPLICATION

The present application is a continuation application of International Patent Application No. PCT/JP2020/017395 filed on Apr. 22, 2020, which designated the U.S. and claims the benefit of priority from Japanese Patent Application No. 2019-092293 filed on May 15, 2019. The entire disclosures of all of the above applications are incorporated herein by reference.

### TECHNICAL FIELD

The present disclosure relates to a centrifugal blower.

### BACKGROUND

Conventionally, a one-sided suction type centrifugal blower is known, which capable of sucking simultaneously air inside a cabin (hereinafter, also referred to as inside air) and air outside the cabin (hereinafter, also referred to as outside air) in separated manner from each other.

### SUMMARY

According to one aspect of the present disclosure, a centrifugal blower configured to suck an inside air inside a cabin and an outside air outside the cabin simultaneously in separated manner, includes:

an inside/outside air box having an outside air introduction port into which the outside air is introduced and an inside air introduction port into which the inside air is introduced;

an impeller that rotates around a rotation axis to suck air introduced into the inside/outside air box from one side in an axial direction of the rotation axis and blow out in a direction away from the rotation axis;

a scroll casing having a spiral outer peripheral wall surrounding an outer side of the impeller in the radial direction and forming an air path with a passage area increased along a rotational direction of the impeller;

a bell mouth portion provided on one side of the scroll casing in the axial direction to form a suction port to the impeller;

a separation cylinder having: an air introduction portion arranged between the bell mouth portion and the inside/outside air box so as to overlap the suction port in the axial direction; and a tubular portion connected to the air introduction portion, at least a part of the tubular portion being arranged inside the impeller, so as to separate the air passing through the suction port into an inner air passing through inside of the tubular portion and an outer air passing through outside of the tubular portion; and

a partition portion arranged inside the scroll casing to partition the air path into a first passage through which the outer air passes and a second passage through which the inner air passes.

The scroll casing has a nose portion where a scroll diameter is minimum, the scroll diameter being a distance from the rotation axis to the outer peripheral wall, and a scroll end portion where the scroll diameter is maximum. The suction port is divided into a first half region to guide air to an upstream of the air path and a second half region to guide air to a downstream of the air path by a reference line passing through the rotation axis and the nose portion. The air introduction portion is arranged so that an area overlapping the first half region in the axial direction is larger than an area overlapping the second half region. At least a part of the outer peripheral wall is set such that a divergence angle from the nose portion to an intermediate portion between the nose portion and the scroll end portion is larger than a divergence angle from the intermediate portion to the scroll end portion.

### BRIEF DESCRIPTION OF THE DRAWINGS

FIG. 1 is a schematic axial sectional view of a centrifugal blower according to a first embodiment.

FIG. 2 is a cross-sectional view taken along a line II-II in FIG. 1.

FIG. 3 is a cross-sectional view taken along a line III-III in FIG. 1.

FIG. 4 is an explanatory diagram for explaining a divergence angle of a scroll casing of the centrifugal blower according to the first embodiment.

FIG. 5 is a cross-sectional view taken along a line V-V in FIG. 1.

FIG. 6 is an explanatory view for explaining how air flows in the centrifugal blower according to the first embodiment.

FIG. 7 is a schematic axial sectional view of a centrifugal blower according to a second embodiment.

FIG. 8 is a cross-sectional view taken along a line VIII-VIII in FIG. 7.

FIG. 9 is an explanatory diagram for explaining a divergence angle of a scroll casing of the centrifugal blower according to the second embodiment.

FIG. 10 is an explanatory view for explaining how air flows in the centrifugal blower according to the second embodiment.

### DESCRIPTION OF EMBODIMENTS

To begin with, examples of relevant techniques will be described.

Conventionally, a one-sided suction type centrifugal blower is known, which capable of sucking simultaneously air inside a cabin (hereinafter, also referred to as inside air) and air outside the cabin (hereinafter, also referred to as outside air) separately from each other. The centrifugal blower is configured such that air taken in from the outside is sucked into the impeller via a filter and blown out to the air path on the outer side of the impeller in the radial direction. The air path on the outer side of the impeller in the radial direction is partitioned by a partition wall into an upper path on one side in the axial direction of the impeller and a lower path on the other side in the axial direction. A separation cylinder is provided inside the impeller in the radial direction to separate the air taken in from the outside into the upper path and the lower path. The separation cylinder has an air introduction portion provided between the impeller and the filter, and a tubular portion shaped to extend from an air inlet formed in the air introduction portion through the radially inner side of the impeller outward in the radial direction. With this configuration, a part of the air taken in from the outside passes from the air inlet of the air introduction portion and flows through the tubular portion, the impeller and the lower path. Further, the rest of the air taken in from the outside passes through the outside of the tubular portion without passing through the air inlet of the air introduction portion, and flows to the upper path through the impeller. The centrifugal blower is configured to blow out air sucked from one side in the axial direction of the impeller in the separated state between the upper path and the lower path.

In the centrifugal blower, a part of the suction port formed in the scroll casing housing the impeller is covered with the air introduction portion of the separation cylinder. Specifically, most of the half region of the suction port that guides air to the upstream of the air path is covered by the air introduction portion of the separation cylinder.

When most of the half region of the suction port is covered by the air introduction portion, a part of the air passing through the outside of the tubular portion of the separation cylinder may flow to the upstream side of the air path via the impeller after being deflected to the back side path of the separation cylinder. The back side path of the separation cylinder is a narrow path formed between the air introduction portion and the bell mouth portion around the suction port. Therefore, the flow rate of the air flowing from the back side path of the separation cylinder to the upstream of the air path is significantly reduced. Such a decrease in the flow rate of air is not preferable because the blowing efficiency of the centrifugal blower may decrease.

On the other hand, for example, it is conceivable to avoid a decrease in the blowing efficiency of the centrifugal blower by enlarging the back side path of the separation cylinder, but in this case, there is a trade-off that the physique of the centrifugal blower becomes large.

The present disclosure provides a centrifugal blower capable of improving air-sending efficiency while suppressing an increase in body size.

According to one aspect of the present disclosure, a centrifugal blower configured to suck inside air inside a cabin and outside air outside the cabin simultaneously in separated manner, includes:

an inside/outside air box having an outside air introduction port into which the outside air is introduced and an inside air introduction port into which the inside air is introduced;

an impeller that rotates around a rotation axis to suck air introduced into the inside/outside air box from one side in an axial direction of the rotation axis and blow out in a direction away from the rotation axis;

a scroll casing having a spiral outer peripheral wall surrounding an outer side of the impeller in the radial direction and forming an air path with a passage area increased along a rotational direction of the impeller;

a bell mouth portion provided on one side of the scroll casing in the axial direction to form a suction port to the impeller;

a separation cylinder having: an air introduction portion arranged between the bell mouth portion and the inside/outside air box so as to overlap the suction port in the axial direction; and a tubular portion connected to the air introduction portion, at least a part of the tubular portion being arranged inside the impeller, so as to separate the air passing through the suction port into an inner air passing through inside of the tubular portion and an outer air passing through outside of the tubular portion; and

a partition portion arranged inside the scroll casing to partition the air path into a first passage through which the outer air passes and a second passage through which the inner air passes.

The scroll casing has a nose portion where a scroll diameter is minimum, the scroll diameter being a distance from the rotation axis to the outer peripheral wall, and a scroll end portion where the scroll diameter is maximum. The suction port is divided into a first half region to guide air to an upstream of the air path and a second half region to guide air to a downstream of the air path by a reference line passing through the rotation axis and the nose portion. The air introduction portion is arranged so that an area overlapping the first half region in the axial direction is larger than an area overlapping the second half region. At least a part of the outer peripheral wall is set such that a divergence angle from the nose portion to an intermediate portion between the nose portion and the scroll end portion is larger than a divergence angle from the intermediate portion to the scroll end portion.

In the scroll casing, when the divergence angle of the outer peripheral wall is large, the passage area of the air path is larger than when the divergence angle is small. Therefore, when the divergence angle of the outer peripheral wall is large, the pressure loss of air is reduced as compared with the case where the divergence angle is small.

In the centrifugal blower of the present disclosure, the divergence angle from the nose portion to the intermediate portion on the outer peripheral wall is larger than the divergence angle from the intermediate portion to the scroll end portion. Therefore, the pressure loss of the air flowing in the upstream of the air path is reduced. Accordingly, since air easily flows from the back side path of the separation cylinder to the upstream of the air path, it is possible to sufficiently secure the flow rate of the air flowing through the air path.

In addition, in the centrifugal blower of the present disclosure, the divergence angle of the outer peripheral wall from the intermediate portion to the scroll end portion is smaller than the divergence angle of the outer peripheral wall from the nose portion to the intermediate portion. Therefore, the increase in size is suppressed.

Thus, according to the centrifugal blower of the present disclosure, it is possible to improve the blowing efficiency while suppressing the increase in the size of the body.

The reference numerals attached to the components and the like indicate an example of correspondence between the components and the like and specific components and the like in embodiments to be described below.

Hereinafter, embodiments of the present disclosure will be described with reference to the drawings. In the following embodiments, portions that are the same as or equivalent to those described in the preceding embodiments are denoted by the same reference numerals, and a description of the same or equivalent portions may be omitted. In addition, when only a part of the components is described in the embodiment, the components described in the preceding embodiment can be applied to other parts of the components. The following embodiments may be partially combined with each other even if such a combination is not explicitly described as long as there is no disadvantage with respect to such a combination.

### First Embodiment

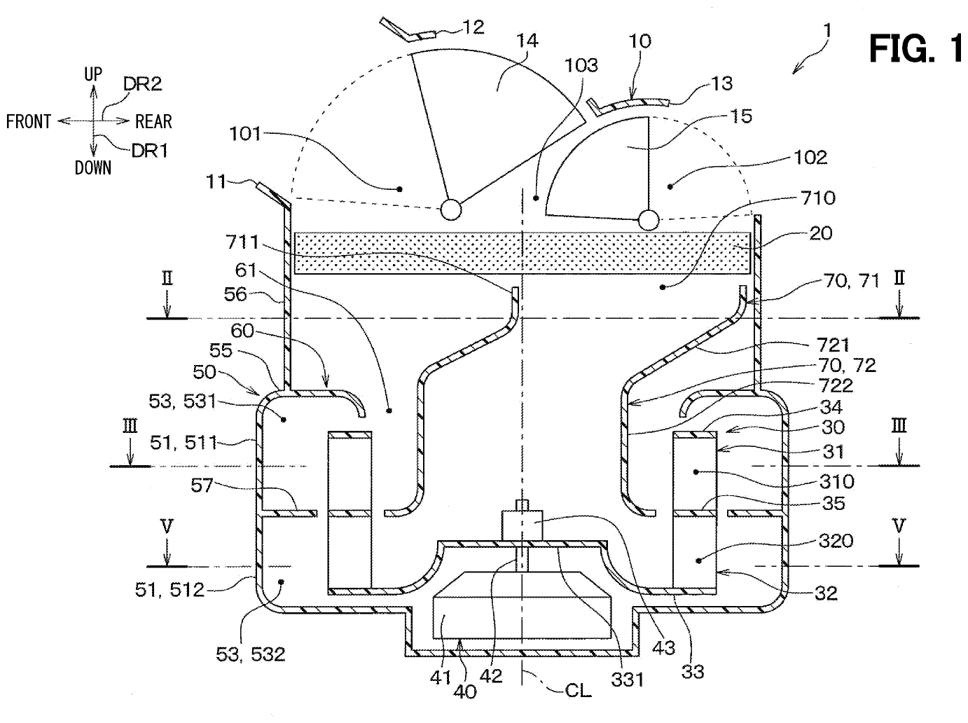

The present embodiment will be described with reference to FIGS. 1 to 6. In the present embodiment, a centrifugal blower 1 of the present disclosure is applied to an air conditioner for a vehicle, and is a two-layer blower capable of blowing outside air and inside air, which are separated from each other, into a cabin.

The centrifugal blower 1 is arranged inside the instrument panel at the front of the cabin. As shown in FIG. 1, the centrifugal blower 1 includes an inside/outside air box 10, a filter 20, an impeller 30, an electric motor 40, a scroll casing 50, a bell mouth portion 60, a partition portion 57, and a separation cylinder 70. The arrows indicating up/down, front/rear, and left/right in each drawing indicate the up/down direction DR1, the front/rear direction DR2, and the left/right direction DR3 when the centrifugal blower 1 is mounted on the vehicle.

The inside/outside air box 10 is arranged on the upper side of the centrifugal blower 1. The upper surface of the inside/outside air box 10 has an outside air introduction port 11 for introducing outside air, a first inside air introduction port 12 for introducing inside air, and a second inside air introduction port 13 for introducing inside air in this order from the front side in the front-rear direction DR2. With such a configuration, it becomes easy to introduce the outside air into the inside/outside air box 10 from the outside of the cabin, and it becomes easy to introduce the inside air into the inside/outside air box 10 from the inside of the cabin.

The inside/outside air box 10 includes a first introduction space 101 into which the outside air from the outside air introduction port 11 or the inside air from the first inside air introduction port 12 is introduced, and a second introduction space 102 into which the inside air from the second inside air introduction port 13 is introduced. The first introduction space 101 and the second introduction space 102 communicate with each other via a communication passage 103.

A first inside/outside air door 14 and a second inside/outside air door 15 are provided in the inside/outside air box 10. The first inside/outside air door 14 selectively opens/closes the outside air introduction port 11 and the first inside air introduction port 12. The second inside/outside air door 15 selectively opens/closes the second inside air introduction port 13 and the communication passage 103. Each of the first inside/outside air door 14 and the second inside/outside air door 15 is composed of a rotary door, but may be composed of a door other than the rotary door. Due to the inside/outside air box 10, the centrifugal blower 1 can suck the inside air and the outside air, at the same time, in separated manner.

The filter 20 is arranged below the inside/outside air box 10. The filter 20 collects foreign substances contained in the air introduced into the inside/outside air box 10. The inside/outside air box 10 and the filter 20 have a rectangular shape when viewed from the upper side.

The impeller 30 is a centrifugal fan that sucks in from one side of the fan axis CL in the axial direction and blows out the sucked air in a direction away from the fan axis CL, which is a rotation axis. The impeller 30 is composed of a sirocco fan. The impeller 30 is not limited to a sirocco fan, and may be composed of a radial fan, a turbo fan, or the like.

The axial direction of the impeller 30 extends along the fan axis CL. The radial direction of the impeller 30 is orthogonal to the fan axis CL and extends radially around the fan axis CL.

The impeller 30 has first blades 31, second blades 32, a main plate 33, a side plate 34, and a separation plate 35. The first blades 31 are arranged side by side around the fan axis CL. A first blade passage 310, through which air flows, is formed between the first blades 31.

The second blades 32 are arranged side by side around the fan axis CL. The second blades 32 are positioned on the other side in the axial direction with respect to the first blades 31. A second blade passage 320, through which air flows, is formed between the second blades 32.

The main plate 33 is a disk-shaped member centered on the fan axis CL. The main plate 33 has a boss portion 331 at the center thereof, to which the shaft 42 of the electric motor 40 is connected so as not to rotate relative to each other. The lower ends of the second blades 32 of the impeller 30 are fixed to the radially outer portion of the main plate 33.

The side plate 34 reinforces the impeller 30. The side plate 34 is formed in a ring shape centered on the fan axis CL. The side plate 34 supports the first blades 31 on the one side in the axial direction.

The separation plate 35 connects the first blades 31 and the second blades 32. The separation plate 35 suppresses the mixing of air flowing through the first blade passage 310 between the first blades 31 and air flowing through the second blade passage 320 between the second blades 32. The separation plate 35 has a ring shape centered on the fan axis CL, and is composed of a plate-shaped member with a plate surface extending so as to intersect the fan axis CL. The separation plate 35 has the plate surface on the one side in the axial direction of the impeller 30, to which the lower end portions of the first blades 31 are fixed, and the plate surface on the other side in the axial direction, to which the upper end portions of the second blades 32 are fixed.

The impeller 30 is configured as an integrally molded product in this way, by a molding technique such as injection molding, by integrally molding the first blades 31, the second blades 32, the main plate 33, the side plate 34, and the separation plate 35.

The electric motor 40 rotates the impeller 30. The electric motor 40 has a main body 41 that generates power for rotating the impeller 30, and a shaft 42 that is rotated by the power of the main body 41.

The shaft 42 extends from the main body 41 toward the one side in the axial direction of the impeller 30. The shaft 42 is fixed to the main plate 33 of the impeller 30 by the motor cap 43. As a result, when the shaft 42 rotates, the impeller 30 rotates.

The scroll casing 50 is a housing that houses the impeller 30 inside. The scroll casing 50 functions to rectify the radial flow of air from the impeller 30 into a flow of air in the circumferential direction of the impeller 30.

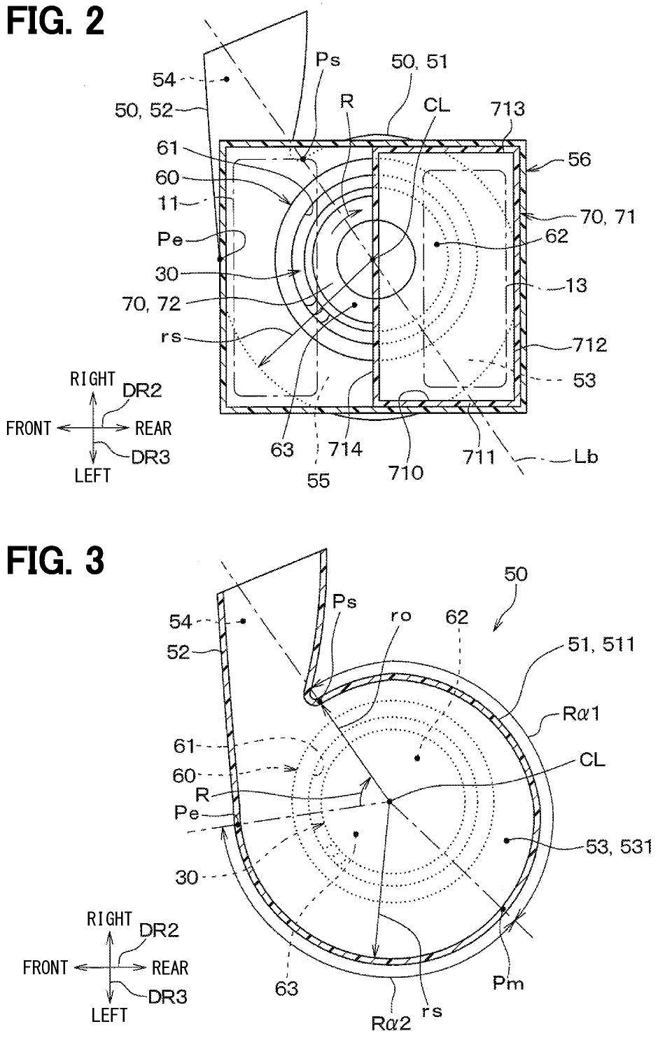

As shown in FIG. 2, the scroll casing 50 has a spiral outer peripheral wall 51 surrounding the impeller 30 in the radial direction and a discharge wall 52 connected to the outer peripheral wall 51. The scroll casing 50 forms a ventilation passage 53 and a discharge passage 54 in which the passage area is increased along the rotational direction R of the impeller 30.

The scroll casing 50 has a nose portion Ps where a scroll diameter rs from the fan axis CL to the outer peripheral wall 51 is the minimum, and a scroll end portion Pe where the scroll diameter rs is the maximum.

The nose portion Ps is a starting point of the ventilation passage 53, and the passage area in the ventilation passage 53 is the minimum at the nose portion Ps. In the present embodiment, the radius line passing through the fan axis CL and the nose portion Ps is set as a reference line Lb. Further, in the present embodiment, the reference line Lb is set as a reference angle (that is, 0°) of the scroll angle θ. The scroll angle θ is an angle in the circumferential direction about the fan axis CL.

The scroll end portion Pe is an end point of the ventilation passage 53, and the passage area in the ventilation passage 53 is the maximum at the scroll end portion Pe. The discharge wall 52 is connected to the scroll end portion Pe. Unlike the outer peripheral wall 51, the discharge wall 52 extends linearly along the left-right direction DR3. The discharge wall 52 forms a discharge passage 54 that blows air toward an air conditioning unit (not shown) of an air conditioner for a vehicle. As a result, the air flowing inside the scroll casing 50 is introduced into the air conditioning unit.

Although not shown, the air conditioning unit adjusts the air introduced from the centrifugal blower 1 to have a desired temperature and blows it into the cabin. The air conditioning unit has a heat exchanger such as an evaporator or a heater core to condition the air introduced from the centrifugal blower 1.

The scroll casing 50 has an upper end portion 55 on the one side in the axial direction of the impeller 30. The upper end portion 55 is provided with a bell mouth portion 60 that forms a suction port 61 to the impeller 30. The bell mouth portion 60 constitutes a peripheral portion of the suction port 61. The bell mouth portion 60 is curved in an arc shape in the cross-section so that air can flow smoothly through the suction port 61. As a result, the air that has passed through the filter 20 is sucked into the impeller 30 from the bell mouth portion 60.

In the present embodiment, the suction port 61 has a first half region 62 that guides the air to an upstream of the ventilation passage 53, and a second half region 63 that guides the air to a downstream of the ventilation passage 53. When the suction port 61 is divided into two regions by the reference line Lb, the first half region 62 is closer to the upstream than the downstream of the ventilation passage 53. When the suction port 61 is divided into two regions by the reference line Lb, the second half region 63 is closer to the downstream than the upstream of the ventilation passage 53.

As shown in FIG. 1, the upper end portion 55 of the scroll casing 50 is provided with an attachment frame 56 for mounting the inside/outside air box 10 and the filter 20. The inside/outside air box 10 and the filter 20 are attached to the attachment frame 56.

A partition portion 57 is disposed inside the scroll casing 50 to partition the ventilation passage 53 and the discharge passage 54 into a first ventilation passage 531 and a second ventilation passage 532. The partition portion 57 is provided at a position corresponding to the separation plate 35 of the impeller 30. The partition portion 57 is provided, for example, so as to overlap the separation plate 35 in the radial direction of the impeller 30. As a result, the air passing through the first blade passage 310 of the impeller 30 flows into the first ventilation passage 531. Further, the air passing through the second blade passage 320 of the impeller 30 flows into the second ventilation passage 532.

The first ventilation passage 531 is formed by the first outer peripheral wall portion 511 of the outer peripheral wall 51. The first outer peripheral wall portion 511 is an upper portion of the outer peripheral wall 51 that overlaps with the first blade 31 in the radial direction. The second ventilation passage 532 is formed by the second outer peripheral wall portion 512 of the outer peripheral wall 51. The second outer peripheral wall portion 512 is a lower portion of the outer peripheral wall 51 that overlaps with the second blade 32 in the radial direction. The details of the first outer peripheral wall portion 511 and the second outer peripheral wall portion 512 will be described later.

The separation cylinder 70 is a tubular member extending in the axial direction of the impeller 30. The separation cylinder 70 is open at both ends in the axial direction. The air passing through the suction port 61 is separated by the separation cylinder 70 into an inner air passing through the inside of the separation cylinder 70 and an outer air passing through the outside of the separation cylinder 70.

The separation cylinder 70 has an air introduction portion 71 arranged between the bell mouth portion 60 and the inside/outside air box 10, and a tubular portion 72 connected to the air introduction portion 71. At least a part of the tubular portion 72 is arranged inside the impeller 30.

The air introduction portion 71 has an air inlet 710 for introducing air into the tubular portion 72. The air inlet 710 is open at the lower side of the second introduction space 102 of the inside/outside air box 10 so that the air introduced into the second introduction space 102 of the inside/outside air box 10 flows into the air inlet 710.

The air introduction portion 71 has a substantially rectangular outer shape when viewed from the one side in the axial direction. The air introduction portion 71 covers substantially half of the suction port 61 and the bell mouth portion 60.

The air introduction portion 71 is arranged so that the area overlapping the front half region 62 of the suction port 61 in the axial direction is larger than the area overlapping the second half region 63 of the suction port 61. Specifically, the air introduction portion 71 covers a portion of the suction port 61 and the bell mouth portion 60 that overlaps with the second introduction space 102 in the up-down direction DR1.

The air introduction portion 71 has three edge portions 711, 712, 713 in contact with the attachment frame 56 of the scroll casing 50, and an outer edge portion 714 that overlaps the suction port 61 in the axial direction. The outer edge portion 714 is not in contact with the attachment frame 56 of the scroll casing 50.

The tubular portion 72 is connected to the air introduction portion 71. The tubular portion 72 has an upper portion 721 connected to the air introduction portion 71 and a lower portion 722 located inside the scroll casing 50. The upper portion 721 is inclined relative to the axial direction, and the lower portion 722 extends vertically along the fan axis CL.

The tubular portion 72 is inclined to the axial direction so that the center axis at the lower end of the upper portion 721 connected to the air introduction portion 71 intersects the fan axis CL. Further, the lower portion 722 of the tubular portion 72 is shaped to spread in the radial direction as extending toward the other side in the axial direction.

The lower end of the lower portion 722 is provided at a position corresponding to the separation plate 35 of the impeller 30. The lower end of the lower portion 722 is provided, for example, so as to overlap the separation plate 35 in the radial direction of the impeller 30. As a result, the inner air passing through the inside of the separation cylinder 70 flows into the second blade passage 320 of the impeller 30. Further, the inner air passing through the outside of the separation cylinder 70 flows into the first blade passage 310 of the impeller 30.

Subsequently, the first outer peripheral wall portion 511 and the second outer peripheral wall portion 512 will be described with reference to FIGS. 3, 4, and 5. The first outer peripheral wall portion 511 and the second outer peripheral wall portion 512 are formed by a scroll curve starting from the nose portion Ps and having a predetermined divergence angle. The divergence angle α is obtained based on a radial component Com and a circumferential component Cou of the outflow velocity of the air blown from the impeller 30 (for example, α=arctan [Com/Cou]).

In the first outer peripheral wall portion 511, a divergence angle α1 from the nose portion Ps to an intermediate portion Pm set between the nose portion Ps and the scroll end portion Pe is larger than a divergence angle α2 from the intermediate portion Pm to the scroll end portion Pe.

As shown in FIG. 3, the first outer peripheral wall portion 511 has a scroll curve in which a range Rα1 from the nose portion Ps to the intermediate portion Pm is formed by the constant divergence angle α1. Further, the first outer peripheral wall portion 511 has a scroll curve in which a range Rα2 from the intermediate portion Pm to the scroll end portion Pe is formed by the constant divergence angle α2. The divergence angle α1 is larger than the divergence angle α2.

The scroll diameter rs of the first outer peripheral wall portion 511 increases as the scroll angle θ increases. For example, the scroll diameter rs of the first outer peripheral wall portion 511 changes in a logarithmic spiral as shown by the following mathematical formula F1 within the range Rα1 from the nose portion Ps to the intermediate portion Pm, and changes in a logarithmic spiral as shown by the following mathematical formula F2 within the range Rα2 from the intermediate portion Pm to the scroll end portion Pe.

rc=r0×exp[θ×tan α1] (F1)

rc=r0×exp[θ×tan α2] (F2)

r0 in the formula F1, F2 is the scroll diameter rs at the nose portion Ps.

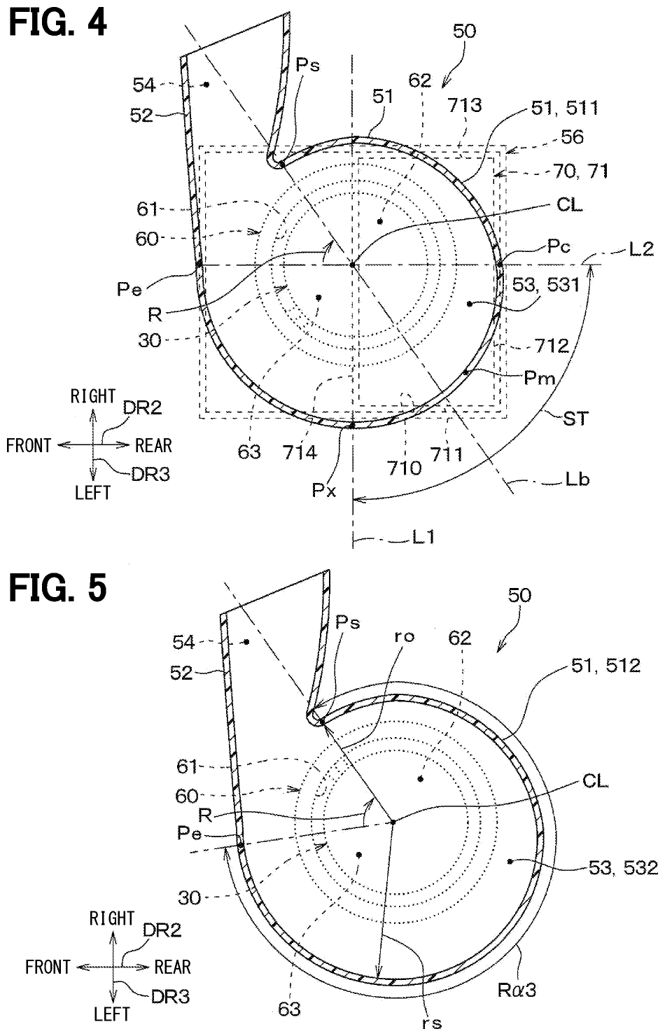

The intermediate portion Pm is a change point for changing the divergence angle in the first outer peripheral wall portion 511. The setting range of the intermediate portion Pm will be described with reference to FIG. 4. In FIG. 4, a first virtual line L1 extends along the outer edge portion 714 of the air introduction portion 71, and a second virtual line L2 extends in a direction orthogonal to the outer edge portion 714 and passes through the fan axis CL.

As shown in FIG. 4, the first outer peripheral wall portion 511 intersects the second virtual line L2 at the rearmost position. Hereinafter, the position of the first outer peripheral wall portion 511 that intersects with the second virtual line L2 will be referred to as an intersection position Pc.

The intersection position Pc equally divides a region in the first ventilation passage 531 where air flows in from the flow path between the air introduction portion 71 and the bell mouth portion 60 into an upstream region and a downstream region. Therefore, the divergence angle α1 of the first outer peripheral wall portion 511 becomes large within the wide range from the nose portion Ps to the intermediate portion Pm, by setting the intermediate portion Pm at the intersection position Pc on the first outer peripheral wall portion 511 or a position advanced from the intersection position Pc in the rotational direction R of the impeller 30. As a result, the flow rate of air flowing upstream of the first ventilation passage 531 increases.

Further, the first outer peripheral wall portion 511 intersects the first virtual line L1 at the rightmost position and the leftmost position. Hereinafter, the position intersecting the first virtual line L1 on the first outer peripheral wall portion 511 and advanced from the intersection position Pc in the rotational direction R of the impeller 30 is referred to as an extension position Px.

The extension position Px is the most downstream position of the first ventilation passage 531 in the region where air flows in from the flow path between the air introduction portion 71 and the bell mouth portion 60. Even if the intermediate portion Pm is set to a position advanced in the rotational direction R of the impeller 30 from the extension position Px, the air flow between the air introduction portion 71 and the bell mouth portion 60 is hardly affected.

Therefore, In the first outer peripheral wall portion 511 of the present embodiment, the intermediate portion Pm is set within the range ST from the intersection position Pc to the extension position Px. Specifically, the intermediate portion Pm is set at a position substantially intermediate between the intersection position Pc and the extension position Px on the first outer peripheral wall portion 511.

On the other hand, the second outer peripheral wall portion 512 has a constant divergence angle α3 from the nose portion Ps to the scroll end portion Pe. Note that the constant divergence angle does not mean a state in which the divergence angle does not change in a strict sense, but also includes a state in which the divergence angle slightly changes due to a manufacturing error or the like.

As shown in FIG. 5, the second outer peripheral wall portion 512 is composed of a scroll curve in which the range Rα3 from the nose portion Ps to the scroll end portion Pe is formed by the constant divergence angle α3. The scroll diameter rs of the second outer peripheral wall portion 512 increases as the scroll angle θ increases. For example, the scroll diameter rs of the second outer peripheral wall portion 512 changes in a logarithmic spiral as shown by the following mathematical formula F3 in the range Rα3 from the nose portion Ps to the scroll end portion Pe.

rc=r0×exp[θ×tan α3] (F3)

Here, the divergence angle α1, α2 of the first outer peripheral wall portion 511 and the divergence angle α3 of the second outer peripheral wall portion 512 are set as shown by the following mathematical formula F4.

α2<α3<α1 (F4)

For example, the divergence angle α1 of the first outer peripheral wall portion 511 is set to a value obtained by adding a predetermined angle Δα to the divergence angle α3 of the second outer peripheral wall portion 512. Further, the divergence angle α2 of the first outer peripheral wall portion 511 is set to a value obtained by subtracting a predetermined angle Δα from the divergence angle α3 of the second outer peripheral wall portion 512. In the present embodiment, the divergence angle α1 of the first outer peripheral wall portion 511 is 4.5 [deg], the divergence angle α2 of the first outer peripheral wall portion 511 is 2.5 [deg], and the divergence angle α3 of the second outer peripheral wall portion 512 is 3.5 [deg].

Next, the operation of the centrifugal blower 1 will be described. The centrifugal blower 1 has an air suction mode such as an outside air mode for sucking outside air, an inside air mode for sucking inside air, and an inside/outside air mode for sucking the outside air and the inside air at the same time in separated manner.

At the outside air mode, only the outside air is introduced into the inside/outside air box 10. The centrifugal blower 1 is configured, at the outside air mode, such that the first inside/outside air door 14 is displaced at a position where the outside air introduction port 11 is opened and the second inside/outside air door 15 is displaced at a position where the communication passage 103 is opened.

At the inside air mode, only the inside air is introduced into the inside/outside air box 10. The centrifugal blower 1 is configured, at the inside air mode, the first inside/outside air door 14 is displaced at a position where the first inside air introduction port 12 is opened, and the second inside/outside air door 15 is displaced at a position where the second inside air introduction port 13 is opened.

At the inside/outside air mode, outside air and inside air are introduced into the inside/outside air box 10. The centrifugal blower 1 is configured, at the inside/outside air mode, such that the first inside/outside air door 14 is displaced to a position where the outside air introduction port 11 is opened, and the second inside/outside air door 15 is displaced to a position where the second inside air introduction port 13 is opened.

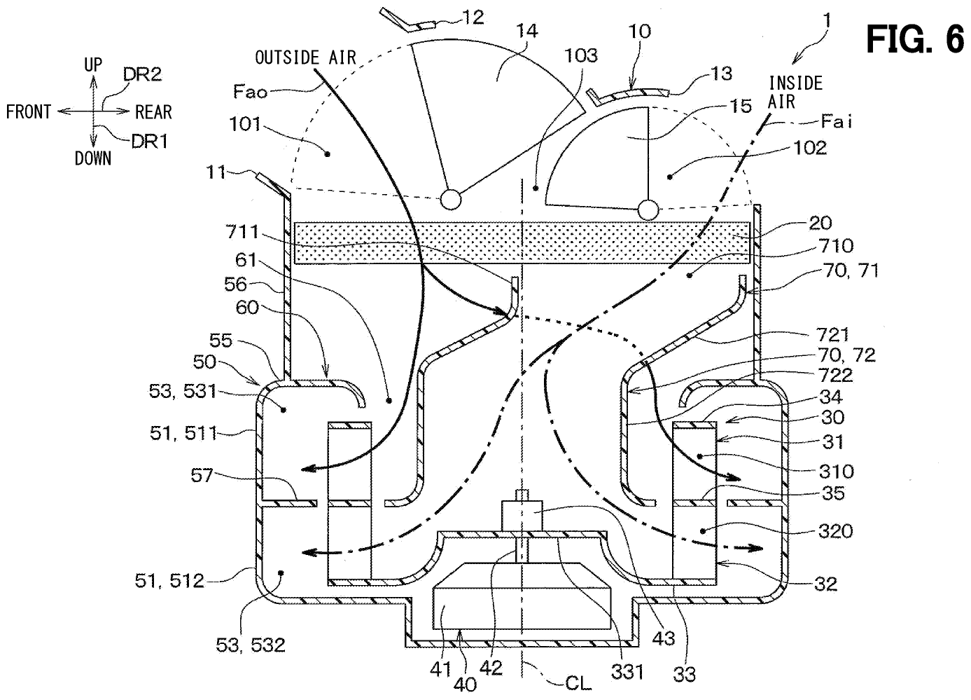

As shown in FIG. 6, in the centrifugal blower 1, when the impeller 30 is rotated by the electric motor 40 at the inside/outside air mode, outside air is introduced from the outside air introduction port 11 into the first introduction space 101 and inside air is introduced from the second inside air introduction port 13 into the second introduction space 102.

As shown by the solid line arrow Fao in FIG. 6, the outside air introduced into the first introduction space 101 is sucked into the first blade passage 310 of the impeller 30 via the outside of the separation cylinder 70. The outside air sucked into the first blade passage 310 is blown out to the first ventilation passage 531.

In the centrifugal blower 1 of the present embodiment, the divergence angle α1 from the nose portion Ps to the intermediate portion Pm on the first outer peripheral wall portion 511 is larger than the divergence angle α2 from the intermediate portion Pm to the scroll end portion Pe. Therefore, the ventilation resistance upstream of the first ventilation passage 531 is reduced, and the pressure loss of the air flowing upstream of the first ventilation passage 531 is reduced. According to this, since air easily flows from the back side path of the separation cylinder 70 to the upstream of the first ventilation passage 531, it is possible to sufficiently secure the flow rate of the air flowing through the first ventilation passage 531.

On the other hand, as shown by the alternate long and short dash arrow Fai in FIG. 6, the inside air introduced into the second introduction space 102 is sucked into the second blade passage 320 of the impeller 30 via the inside of the separation cylinder 70. The inside air sucked into the second blade passage 320 is blown out to the second ventilation passage 532.

Although not shown, the outside air flowing through the first ventilation passage 531 and the inside air flowing through the second ventilation passage 532 are introduced into the air conditioning unit from the scroll casing 50, adjusted to have a desired temperature inside the air conditioning unit, and then blown into the cabin from different outlets.

In the centrifugal blower 1 described above, the divergence angle α1 from the nose portion Ps to the intermediate portion Pm on the first outer peripheral wall portion 511 of the scroll casing 50 is larger than the divergence angle α2 from the intermediate portion Pm to the scroll end portion Pe.

According to this, the pressure loss of the air flowing upstream of the first ventilation passage 531 is reduced. Therefore, air easily flows from the back side path of the separation cylinder 70 to the upstream of the first ventilation passage 531, and it is possible to sufficiently secure the flow rate of the air flowing through the first ventilation passage 531.

Further, since the divergence angle α2 from the intermediate portion Pm to the scroll end portion Pe on the first outer peripheral wall portion 511 is smaller than the divergence angle α1 of the first outer peripheral wall portion 511 from the nose portion Ps to the intermediate portion Pm, the increase in the size of the scroll casing 50 is suppressed.

According to the centrifugal blower 1 of the present embodiment, it is possible to improve the blowing efficiency while suppressing the increase in the size of the body.

Unlike the first ventilation passage 531, the second ventilation passage 532 allows air that has passed through the inside of the separation cylinder 70 to flow. Therefore, a pressure loss of air is unlikely to occur at the upstream of the second ventilation passage 532. If the second outer peripheral wall portion 512 is changed in the divergence angle in the same manner as the first outer peripheral wall portion 511, the air flow downstream of the second ventilation passage 532 may be unnecessarily restricted.

Taking these factors into consideration, the second outer peripheral wall portion 512 has a constant divergence angle α3 from the nose portion Ps to the intermediate portion Pm. According to this, since the air flow downstream of the second ventilation passage 532 is not unnecessarily restricted, it is possible to sufficiently secure the flow rate of the air flowing through the second ventilation passage 532.

Specifically, in the centrifugal blower 1, the intermediate portion Pm is set at the intersection position Pc on the first outer peripheral wall portion 511 or a position advanced from the intersection position Pc in the rotational direction R of the impeller 30. According to this, the divergence angle is increased in a wide range from the nose portion Ps to the intermediate portion Pm, and the pressure loss of the air flowing upstream of the first ventilation passage 531 is sufficiently reduced. As a result, air easily flows from the back side path of the separation cylinder 70 to the upstream of the first ventilation passage 531.

Further, in the centrifugal blower 1, the intermediate portion Pm is set in the range from the intersection position Pc to the extension position Px. It is possible to suppress the increase in the size of the scroll casing 50 while ensuring the flow rate of the air flowing through the first ventilation passage 531, by limiting the intermediate portion Pm to the range up to the extension position Px.

### Second Embodiment

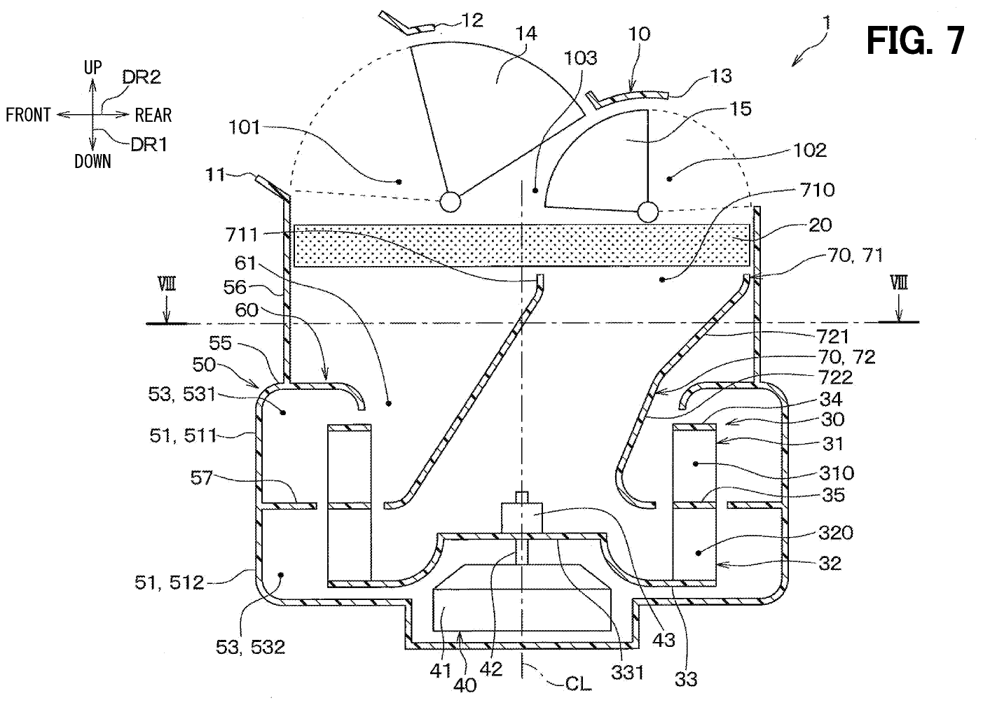

Next, a second embodiment will be described with reference to FIGS. 7 to 10. In this embodiment, the different portions from the first embodiment are mainly described and descriptions of portions similar to the first embodiment will be omitted.

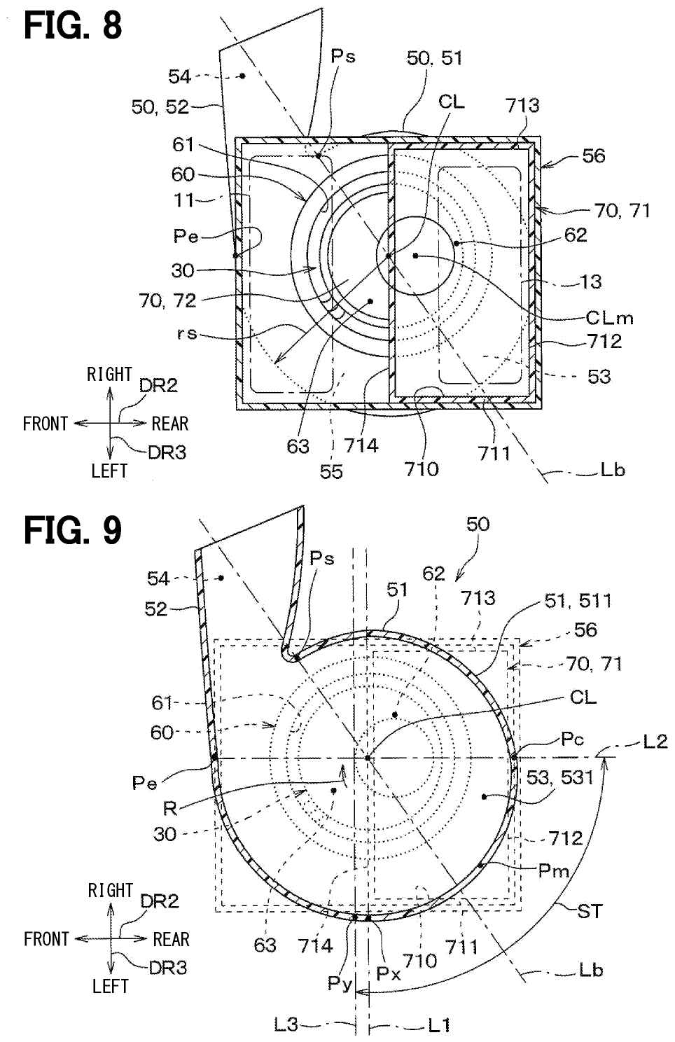

The centrifugal blower 1 of the present embodiment is configured such that most of the tubular portion 72 of the separation cylinder 70 overlaps with the air introduction portion 71 in the axial direction in the vicinity of the suction port 61. As shown in FIG. 7, in the separation cylinder 70 of the present embodiment, each of the upper portion 721 and the lower portion 722 is inclined relative to the axial direction such that the center axis at the lower end of the lower portion 722 of the tubular portion 72 intersects the fan axis CL. Specifically, as shown in FIG. 8, the center CLm of the tubular portion 72 near the suction port 61 is located on the rear side of the fan axis CL.

In such a configuration, the area of the region covered by the air introduction portion 71 is smaller than the area of the region that is not covered by the air introduction portion 71, of the suction port 61 outside the tubular portion 72. Therefore, the pressure loss of the air flowing through the region covered by the air introduction portion 71 becomes large, and there is a concern that the flow rate of the air flowing from the back side path of the separation cylinder 70 to the upstream of the first ventilation passage 531 decreases.

Subsequently, the setting range of the intermediate portion Pm in the first outer peripheral wall portion 511 of the present embodiment will be described with reference to FIG. 9. In FIG. 9, a third virtual line L3 is parallel to the outer edge portion 714 of the air introduction portion 71 and extends to equally divide the region of the suction port 61 outside the tubular portion 72, of the first outer peripheral wall portion 511.

As shown in FIG. 9, the first outer peripheral wall portion 511 intersects the first virtual line L1 at the leftmost extension position Px, and intersects the third virtual line L3 at a position slightly front of the extension position Px. Hereinafter, the position of the first outer peripheral wall portion 511 that intersects with the third virtual line L3 is referred to as an equally dividing position Py.

The equally dividing position Py is a position advanced in the rotational direction R of the impeller 30 from the intersection position Pc and the extension position Px. Therefore, if the equally dividing position Py is set as the upper limit of the set position of the intermediate portion Pm, the air can easily flow from the back side path of the separation cylinder 70 to the upstream of the first ventilation passage 531, while the pressure loss of the air flowing through the region covered by the air introduction portion 71 becomes large.

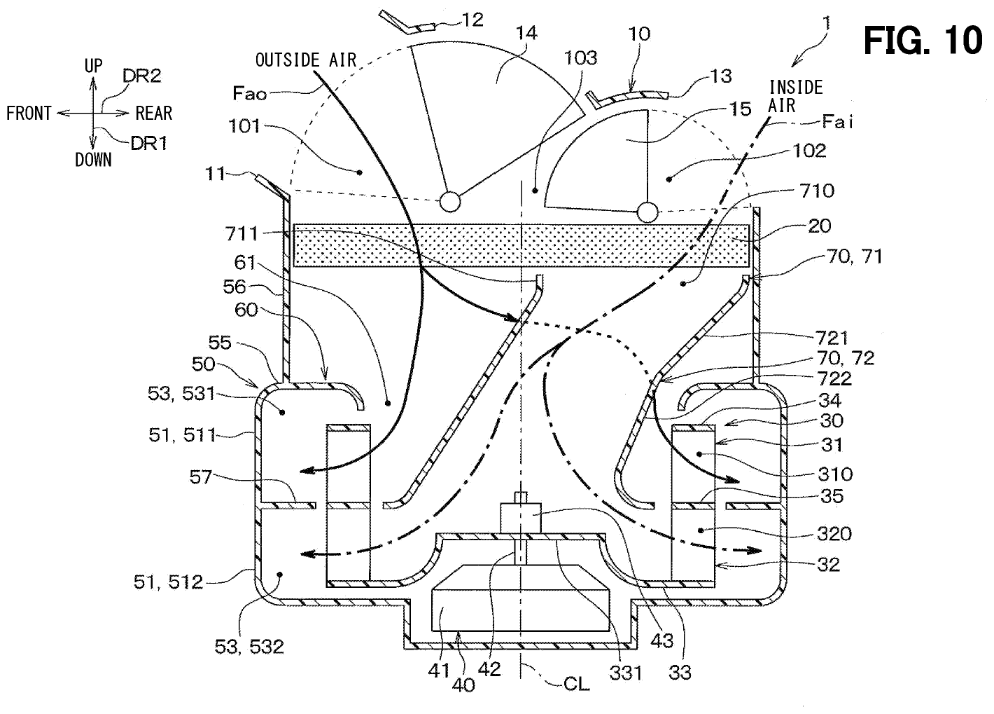

In the centrifugal blower 1 of the present embodiment configured as described above, as shown in FIG. 10, at the inside/outside air mode, outside air is introduced from the outside air introduction port 11 into the first introduction space 101 and inside air is introduced from the second inside air introduction port 13 into the second introduction space 102.

As shown by the solid line arrow Fao in FIG. 10, the outside air introduced into the first introduction space 101 is sucked into the first blade passage 310 of the impeller 30 via the outside of the separation cylinder 70. The outside air sucked into the first blade passage 310 is blown out to the first ventilation passage 531.

In the centrifugal blower 1 of the present embodiment, the divergence angle α1 from the nose portion Ps to the intermediate portion Pm on the first outer peripheral wall portion 511 is larger than the divergence angle α2 from the intermediate portion Pm to the scroll end portion Pe. Therefore, the flow resistance of air upstream of the first ventilation passage 531 is reduced, and the pressure loss of the air flowing upstream of the first ventilation passage 531 is reduced. According to this, since air easily flows from the back side path of the separation cylinder 70 to the upstream of the first ventilation passage 531, it is possible to sufficiently secure the flow rate of the air flowing through the first ventilation passage 531.

In the centrifugal blower 1 of the present embodiment, the upper limit of the set position of the intermediate portion Pm is not the extension position Px but the equally dividing position Py. That is, in the first outer peripheral wall portion 511 of the present embodiment, the intermediate portion Pm is set to the range ST from the intersection position Pc to the equally dividing position Py. According to this, the intermediate portion Pm can be set at an appropriate position in consideration of the pressure loss on the suction port 61 side.

As shown by the alternate long and short dash arrow Fai in FIG. 10, the inside air introduced into the second introduction space 102 is sucked into the second blade passage 320 of the impeller 30 via the inside of the separation cylinder 70. The inside air sucked into the second blade passage 320 is blown out to the second ventilation passage 532.

The centrifugal blower 1 described above has the same configuration as that of the first embodiment. Therefore, the centrifugal blower 1 of the present embodiment can obtain the same effect as that of the first embodiment from the same configuration as that of the first embodiment.

In the centrifugal blower 1, the equally dividing position Py is the upper limit of the set position of the intermediate portion Pm, so that the intermediate portion Pm can be set to an appropriate position in consideration of the pressure loss on the suction port 61 side. For example, when the pressure loss of the air flowing through the region covered by the air introduction portion 71 at the suction port 61 becomes large, the intermediate portion Pm is made closer to the equally dividing position Py than the extension position Px. Thus, air can easily flow from the back side path of the separation cylinder 70 to the upstream of the first ventilation passage 531.

### Other Embodiment

The embodiments of the present disclosure have been described above. However, the present disclosure is not limited to the embodiments, and may be be variously modified as follows.

As in the embodiment, it is desirable, but not limited to, the lower limit of the setting range of the intermediate portion Pm is set at the intersection position Pc. The intermediate portion Pm may be set at a position between the nose portion Ps and the intersection position Pc.

As in the embodiment, it is desirable, but not limited to, the upper limit of the setting range of the intermediate portion Pm is set at the extension position Px or the equally dividing position Py. The intermediate portion Pm may be set at a position from the equal dividing position Py to the scroll end portion Pe.

As in the embodiment, it is desirable, but not limited to, the upper limit of the setting range of the intermediate portion Pm is set at the extension position Px or the equal dividing position Py. The intermediate portion Pm may be set at a position from the equal dividing position Py to the scroll end portion Pe.

As in the embodiment, it is desirable, but not limited to, that the second outer peripheral wall portion 512 has a constant divergence angle α3 from the nose portion Ps to the scroll end portion Pe. In the second outer peripheral wall portion 512, for example, similarly to the first outer peripheral wall portion 511, the divergence angle from the nose portion Ps to the intermediate portion Pm may be larger than the divergence angle from the intermediate portion Pm to the scroll end portion Pe.

In the embodiments described above, it is needless to say that the elements configuring the embodiments are not necessarily essential except in the case where those elements are clearly indicated to be essential in particular, the case where those elements are considered to be obviously essential in principle, and the like.

In the embodiments described above, the present disclosure is not limited to the specific number of components of the embodiments, except when numerical values such as the number, numerical values, quantities, ranges, and the like are referred to, particularly when it is expressly indispensable, and when it is obviously limited to the specific number in principle, and the like.

In the embodiments described above, when referring to the shape, positional relationship, and the like of a component, it is not limited to the shape, positional relationship, and the like, except for the case where it is specifically specified and the case where it is fundamentally limited to a specific shape, positional relationship, and the like.

### (Overview)

According to the first aspect shown in part or all of the embodiments, the centrifugal blower includes an inside/outside air box, an impeller, a scroll casing, a bell mouth portion, a separation cylinder, and a partition portion. The outer peripheral wall of the scroll casing is formed such that the divergence angle from the nose portion to the intermediate portion set between the nose portion and the scroll end portion is larger than the divergence angle from the intermediate portion to the scroll end portion.

According to the second aspect, the air introduction portion has an outer edge portion that overlaps with the suction port in the axial direction. The intermediate portion is set at an intersection position or a position advanced in the rotational direction of the impeller from the intersection position. The intermediate portion is set at a position of the outer peripheral wall that intersects with a virtual line passing through the rotation axis and extending in a direction orthogonal to the outer edge portion.

The intersection position on the outer peripheral wall equally divides the region of the air path where air flows in from the flow path between the air introduction portion and the bell mouth portion in into an upstream region and a downstream region. Therefore, if the intermediate portion is set at the intersection position on the outer peripheral wall or a position advanced in the rotational direction of the impeller from the intersection position, the divergence angle becomes large in a wide range from the nose portion to the intermediate portion. According to this, the pressure loss of the air flowing upstream of the air path is sufficiently reduced. As a result, air can easily flow from the back side path of the separation cylinder to the upstream of the air path.

According to the third aspect, the intermediate portion is set in the range from the intersection position to the extension position. However, it is the position of the outer peripheral wall that intersects a virtual line extending along the outer edge portion and advanced from the intersection position in the rotational direction of the impeller.

The extension position on the outer peripheral wall is the most downstream position of the air path where air flows from the flow path between the air introduction portion and the bell mouth portion. Therefore, if the intermediate portion is set in the range from the intersection position to the extension position, the divergence angle of the outer peripheral wall becomes large in a wide range from the nose portion to the intermediate portion. According to this, the pressure loss of the air flowing upstream of the air path is sufficiently reduced, so that the air can easily flow from the back side path of the separation cylinder to the upstream of the air path. In particular, since the intermediate portion is limited to the range up to the extension position, it is possible to suppress the increase in the size of the scroll casing while ensuring the flow rate of the air flowing through the air path.

According to the fourth aspect, the intermediate portion is set in the range from the intersection position to the equally dividing position. However, the equally dividing position on the outer peripheral wall is positioned advanced in the rotational direction of the impeller from the intersection position, of the position intersecting with a virtual line parallel to the outer edge portion and that extends so as to equally divide the region of the suction port outside the tubular portion.

In case where most of the tubular portion of the separation cylinder is configured to overlap the air introduction portion in the axial direction in the vicinity of the suction port, the area covered with the air introduction portion is smaller than the area not covered by the air introduction portion, of the area of the suction port outside the tubular portion. In this case, the pressure loss of the air flowing through the region covered by the air introduction portion becomes large, and there is a concern that the flow rate of the air flowing from the back side path of the separation cylinder to the upstream of the air path decreases.

In contrast, when the equally dividing position is set as the upper limit of the set position of the intermediate portion, the air can be made easily flow from the back side path of the separation cylinder to the upstream of the air path. The position intersecting a virtual line extending so as to equally divide the outer region of the tubular portion at the suction port is set as the equally dividing position.

According to the fifth aspect, the outer peripheral wall has a first portion forming a first air path and a second portion forming a second air path. In the first portion, the divergence angle from the nose portion to the intermediate portion is larger than the divergence angle from the intermediate portion to the scroll end portion. The second portion has a constant divergence angle from the nose portion to the scroll end portion.

According to this, the divergence angle from the nose portion to the intermediate portion on the first portion is larger than the divergence angle from the intermediate portion to the scroll end portion. Therefore, the pressure loss of the air flowing upstream of the first air path is reduced. As a result, air can easily flow from the back side path of the separation cylinder to the upstream of the first air path, so that the flow rate of the air flowing through the first air path can be sufficiently secured.

Unlike the first air path, the second air path allows air that has passed through the inside of the separation cylinder to flow, so that a pressure loss is not generated in air upstream of the second air path. Despite this, if the divergence angle is changed in the second portion in the same manner as the first portion, there is a possibility that the air flow downstream of the second air path is unnecessarily restricted.

Taking these factors into consideration, the second portion has a constant divergence angle from the nose portion to the intermediate portion. According to this, since the air flow downstream of the second air path is not unnecessarily restricted, it is possible to sufficiently secure the flow rate of the air flowing through the second air path.

What is claimed is:

1. A centrifugal blower configured to suck an inside air inside a cabin and an outside air outside the cabin simultaneously in separated manner, comprising:
an inside/outside air box having an outside air introduction port into which the outside air is introduced and an inside air introduction port into which the inside air is introduced;
an impeller that rotates around a rotation axis to suck air introduced into the inside/outside air box from one side in an axial direction of the rotation axis and blow out in a direction away from the rotation axis;
a scroll casing having a spiral outer peripheral wall surrounding an outer side of the impeller in a radial direction and forming an air path with a passage area increased along a rotational direction of the impeller;
a bell mouth portion provided on one side of the scroll casing in the axial direction to form a suction port to the impeller;
a separation cylinder having
an air introduction portion arranged between the bell mouth portion and the inside/outside air box so as to overlap the suction port in the axial direction, and
a tubular portion connected to the air introduction portion, at least a part of the tubular portion being arranged inside the impeller, so as to separate the air passing through the suction port into an inner air passing through inside of the tubular portion and an outer air passing through outside of the tubular portion; and
a partition portion arranged inside the scroll casing to partition the air path into a first passage through which the outer air passes and a second passage through which the inner air passes, wherein
the scroll casing has a nose portion where a scroll diameter is minimum, the scroll diameter being a distance from the rotation axis to the outer peripheral wall, and a scroll end portion where the scroll diameter is maximum,
the suction port is divided into a first half region to guide air to an upstream of the air path and a second half region to guide air to a downstream of the air path by a reference line passing through the rotation axis and the nose portion,
the air introduction portion is arranged to have an area overlapping the first half region in the axial direction, which is larger than an area overlapping the second half region, and
at least a part of the outer peripheral wall is set such that a divergence angle from the nose portion to an intermediate portion between the nose portion and the scroll end portion is larger than a divergence angle from the intermediate portion to the scroll end portion.

2. The centrifugal blower according to claim 1, wherein
the air introduction portion has an outer edge portion that overlaps with the suction port in the axial direction,
the outer peripheral wall has an intersection position intersecting with a virtual line passing through the rotation axis and extending in a direction orthogonal to the outer edge portion, and
the intermediate portion is set at the intersection position or a position advanced from the intersection position in the rotational direction of the impeller.

3. The centrifugal blower according to claim 2, wherein
the outer peripheral wall has an extension position intersecting with a virtual line extending along the outer edge portion, the extension position being advanced from the intersection position in the rotational direction of the impeller, and
the intermediate portion is set within a range from the intersection position to the extension position.

4. The centrifugal blower according to claim 2, wherein
the outer peripheral wall has an equally dividing position intersecting with a virtual line parallel to the outer edge portion and extending so as to equally divide a region of the suction port outside of the tubular portion, the equally dividing position being advanced from the intersection position in the rotational direction of the impeller, and
the intermediate portion is set within a range from the intersection position to the equally dividing position.

5. The centrifugal blower according to claim 1, wherein
the outer peripheral wall has a first portion forming the first passage and a second portion forming the second passage,
the first portion is set such that the divergence angle from the nose portion to the intermediate portion is larger than the divergence angle from the intermediate portion to the scroll end portion, and
the second portion is set such that the divergence angle from the nose portion to the scroll end portion is constant.
